(19) United States
(12) Patent Application Publication
(10) Pub. No.: US 2025/0055143 A1
(43) Pub. Date: Feb. 13, 2025

(54) ELECTRODE ASSEMBLY FOR RECHARGEABLE LITHIUM BATTERY, AND RECHARGEABLE LITHIUM BATTERY INCLUDING SAME

(71) Applicant: SAMSUNG SDI CO., LTD., Yongin-si (KR)

(72) Inventors: Duckjae YOU, Yongin-si (KR); Hosung YANG, Yongin-si (KR); Changwon PARK, Yongin-si (KR); Jiye WOO, Yongin-si (KR); Seongho JEON, Yongin-si (KR)

(21) Appl. No.: 18/638,438

(22) Filed: Apr. 17, 2024

(30) Foreign Application Priority Data
Aug. 9, 2023 (KR) 10-2023-0104286

(51) Int. Cl. H01M 50/494; H01M 10/052; H01M 50/42; H01M 50/426; H01M 50/431; H01M 50/443

(52) U.S. Cl. CPC H01M 50/494; H01M 50/42; H01M 50/426; H01M 50/431; H01M 50/443; H01M 10/052

(57) ABSTRACT

An electrode assembly and a rechargeable lithium battery including the same are provided. The electrode assembly includes a current collector; an electrode active material layer on the current collector; and a coating layer combined with the electrode active material layer. The coating layer includes polymer nanofibers each including a structural unit derived from a fluorine-based polymer and a structural unit derived from a nitrile-based polymer; and inorganic particles. The coating layer has a puncture strength of about 15 to about 100 gram force (gf) and a tensile strength of about 120 to about 1,000 kilogram force per square centimeter (kgf/cm²).

### CROSS-REFERENCE TO RELATED APPLICATION

This application claims priority to and the benefit of Korean Patent Application No. 10-2023-0104286, filed on Aug. 9, 2023, in the Korean Intellectual Property Office, the entire content of which is incorporated herein by reference.

### BACKGROUND

### 1. Field

According to one or more embodiments, the present disclosure relates to a rechargeable battery, and an electrode assembly for a rechargeable lithium battery, and, for example, rechargeable battery electrode assemblies, and rechargeable lithium batteries including the electrode assemblies.

### 2. Description of the Related Art

Recently, with the rapid spread of electronic devices that utilize batteries, such as mobile phones, laptop computers, and electric vehicles, and/or the like, the demand or desire for rechargeable batteries with relatively high energy density and/or relatively high capacity is rapidly increasing. Accordingly, research and development to improve the performance of rechargeable lithium batteries is actively underway or being pursued.

A rechargeable lithium battery includes a positive electrode and a negative electrode including an active material capable of intercalating and deintercalating lithium ions, and an electrolyte. For example, electrical energy is produced through oxidation and reduction reactions, if (e.g., when) lithium ions are intercalated/deintercalated from/to the positive electrode and negative electrode.

A typical rechargeable lithium battery includes a non-functional separator between the positive electrode and the negative electrode. Recently, a technology has been proposed to manufacture an electrode assembly by combining (e.g., integrating) a coating layer that functions as a separator with the active material layer of the positive electrode and/or the negative electrode. This technology would increase the energy density of the battery by removing the need for a separate separator (e.g., a separate, non-functional, separator).

However, existing coating layers that also function as a separator in the electrode assembly have experienced reduced or compromised durability as compared to comparable separate separators.

The above information disclosed in this Background section is only for enhancement of understanding of the background of the disclosure and therefore it may contain information that does not constitute prior art.

### SUMMARY

One or more aspects are directed toward an electrode assembly in which a coating layer that functions as a separator is combined (e.g., integrated) with an electrode active material layer and durability is enhanced.

One or more aspects are directed toward a rechargeable lithium battery including the electrode assembly.

Additional aspects will be set forth in part in the description which follows and, in part, will be apparent from the description, or may be learned by practice of the presented embodiments of the disclosure.

According to one or more embodiments, an electrode assembly includes a current collector; an electrode active material layer on the current collector; and a coating layer combined (e.g., integrated) with the electrode active material layer. The coating layer includes a composition of polymer nanofibers that each include a structural unit derived from a fluorine-based polymer and a structural unit derived from a nitrile-based polymer; and a composition of inorganic particles, and the coating layer has a puncture strength of 15 to 100 gram force (gf) and a tensile strength of 120 to 1,000 kilogram force per square centimeter (kgf/cm²).

Some embodiments provide a rechargeable lithium battery including the electrode assembly but (and) excluding (e.g., not including) a separate separator.

The electrode assembly according to some embodiments has enhanced durability while combining (e.g., integrating) the coating layer that functions as a separator with the electrode active material layer, thereby improving the safety (e.g., safety profile) and cycle-life of the rechargeable lithium battery.

### BRIEF DESCRIPTION OF THE DRAWINGS

FIGS. 1-4 are each a schematic view showing a rechargeable lithium battery according to some embodiments of the present disclosure.

### DETAILED DESCRIPTION

Hereinafter, embodiments of the present disclosure will be described in more detail, examples of which are illustrated in the accompanying drawings, wherein like reference numerals refer to like elements throughout, and duplicative descriptions thereof may not be provided. Accordingly, the embodiments are merely described, by referring to the drawings, to explain aspects of the present description. However, these embodiments are merely examples, the present disclosure is not limited thereto and the present disclosure is defined by the scope of claims.

As utilized herein, the term “and/or” includes any and all combinations of one or more of the associated listed items. Expressions such as “at least one of,” “one of,” and “selected from,” if (e.g., when) preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

As utilized herein, if (e.g., when) a specific definition is not otherwise provided, it will be understood that if (e.g., when) an element such as a layer, film, region, or substrate is referred to as being “on” another element, it can be directly on the other element or intervening elements may also be present.

As utilized herein, if (e.g., when) a specific definition is not otherwise provided, the singular may also include the plural. In some embodiments, unless otherwise specified, “A or B” may refer to “including A, including B, or including A and B.”

As utilized herein, the phrase “combination thereof” may refer to a mixture of constituents, a stack, a composite, a copolymer, an alloy, a blend, and a reaction product.

It will be understood that, although the terms “first,” “second,” “third,” and/or the like may be utilized herein to describe one or more suitable elements, components, regions, layers and/or sections, these elements, components, regions, layers and/or sections should not be limited by these terms. These terms are only utilized to distinguish one element, component, region, layer or section from another element, component, region, layer or section. Thus, a first element, component, region, layer or section described herein may be termed a second element, component, region, layer or section without departing from the teachings set forth herein.

The terminology utilized herein is for the purpose of describing particular embodiments only and is not intended to limit the present disclosure. An expression in the singular forms “a,” “an,” and “the” is intended to include an expression in the plural including “at least one,” unless the context clearly indicates otherwise. “At least one” should not be construed as being limited to the singular. It will be further understood that the terms “includes,” “including,” “include,” “having,” “has,” “have,” “comprise,” “comprises” and/or “comprising” as utilized in this specification specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and/or the like, may be utilized herein to easily describe the relationship between one element or feature and another element or feature. It will be understood that the spatially relative terms are intended to encompass different orientations of a device in utilization or operation in addition to the orientation illustrated in the drawings. For example, if (e.g., when) the device in the drawings is turned over, elements described as “below” or “beneath” other elements or features will be oriented “above” the other elements or features. Thus, the example term “below” can encompass both (e.g., simultaneously) the orientations of above and below. The device may be otherwise oriented (rotated 90 degrees or at other orientations), and the spatially relative terms utilized herein may be interpreted accordingly.

The terminology utilized herein is utilized for the purpose of describing particular embodiments only and is not intended to limit the present disclosure. Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

Example embodiments are described herein with reference to cross-sectional views, which are schematic views of idealized embodiments. As such, variations from the shapes of the illustrations as a result, for example, of manufacturing techniques and/or tolerances, are to be expected. Thus, embodiments described herein should not be construed as being limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawings are schematic in nature and their shapes are not intended to illustrate the precise shape of a region and are not intended to limit the scope of the present claims.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

In this context, “consisting essentially of” means that any additional components will not materially affect the chemical, physical, optical or electrical properties of the semiconductor film.

Further, in this specification, the phrase “on a plane,” or “plan view,” means viewing a target portion from the top, and the phrase “on a cross-section” means viewing a cross-section formed by vertically cutting a target portion from the side.

### Definitions

As utilized herein, if (e.g., when) a definition is not otherwise provided, the phrase “particle diameter” may be an average particle diameter. This average particle diameter refers to an average particle diameter (D50), which is a diameter of particles with a cumulative volume of 50 volume % in the particle size distribution. The average particle diameter (D50) can be measured by methods well suitable to those skilled in the art, for example, by measuring with a particle size analyzer, a transmission electron microscope or scanning electron microscope, or a scanning electron microscope. In some embodiments, a dynamic light-scattering measurement device is utilized to perform a data analysis, and the number of particles is counted for each particle size range. From this, the average particle diameter (D50) value may be easily obtained through a calculation. A laser diffraction method may also be utilized. If (e.g., when) measuring by laser diffraction, more specifically, the particles to be measured are dispersed in a dispersion medium and then introduced into a related art laser diffraction particle size measuring device (e.g., MT 3000 available from Microtrac, Ltd.) utilizing ultrasonic waves at about 28 kHz, and after irradiation with an output of 60 W, the average particle diameter (D50) based on 50% of the particle size distribution in the measuring device can be calculated.

The “particle diameter” refers to an average diameter of particles or crystallites if (e.g., when) the particles are spherical, and refers to an average major axis length of particles if (e.g., when) the particles are non-spherical. The “average particle diameter” may be, for example, D50, which is a median particle diameter.

D50 refers to a size of particles corresponding to a cumulative volume of 50% calculated from the side of particles having the smallest particle size in a particle size distribution as measured by a laser diffraction method.

D90 refers to a size of particles corresponding to a cumulative volume of 90% calculated from the side of particles having the smallest particle size in a particle size distribution as measured by a laser diffraction method.

D10 refers to a size of particles corresponding to a cumulative volume of 10% calculated from the side of particles having the smallest particle size in a particle size distribution as measured by a laser diffraction method.

In present disclosure, “not include a or any ‘component’” “exclude a or any ‘component”, “‘component’-free”, and/or the like refers to that the “component” not being added, selected or utilized as a component in the composition/structure, but the “component” of less than a suitable amount may still be included due to other impurities and/or external factors.

While embodiments have been described, alternatives, modifications, variations, improvements, and substantial equivalents that are currently unexpected or unforeseeable may be made by the applicant or those of ordinary skill in the art. Thus, it is intended that the appended claims, which may be filed and amended, include all such alternatives, modifications, variations, improvements and substantial equivalents.

Hereinafter, an electrode assembly according to one or more embodiments, a method of manufacturing the same, and a rechargeable lithium battery including the electrode assembly are described in more detail.

### Electrode Assembly

Some embodiments provide an electrode assembly including a current collector; an electrode active material layer on the current collector; and a coating layer combined (e.g., integrated) with the electrode active material layer. The coating layer includes a composition of polymer nanofibers, each polymer nanofiber including a structural unit derived from a fluorine-based polymer and a structural unit derived from a nitrile-based polymer; and a composition of inorganic particles, and the coating layer may have a puncture strength of about 15 to about 100 gf and a tensile strength of about 120 to about 1,000 kgf/cm².

### Function of Coating Layer

In some embodiments, the coating layer may function as a separator.

Accordingly, if (e.g., when) the electrode assembly for a rechargeable lithium battery according to some embodiments is utilized, because neither a separate separator nor a lamination process of the separator with an electrode is required, a battery may be economically manufactured by utilizing the electrode assembly.

The combination (e.g., integration) of the coating layer with the electrode active material layer refers to that a portion of the coating layer is incorporated into the electrode active material layer and firmly coupled therewith.

Accordingly, if (e.g., when) the electrode assembly for a rechargeable lithium battery according to some embodiments is examined with scanning electron microscopy (SEM) and/or the like, the interface between the electrode active material layer and the coating layer may appear uneven and non-flat.

For example, a polypropylene film is comparably utilized as a separator. If (e.g., when) the polypropylene film is repeatedly charged and discharged, the size of the film may change (e.g., due to heat shrinkage and/or the like). As a result, the film may not properly function to separate (e.g., electrochemically) the positive and negative electrodes, thereby causing a short circuit and/or the like.

In contrast, the electrode assembly according to some embodiments, having the coating layer combined (e.g., integrated) with the electrode active material layer, and that functions as a separator, may improve heat resistance and insulating properties and concurrently reduce resistance (e.g., internal resistance of electrode and/or battery).

### Physical Properties of Coating Layer

As an example, by (1) electrospinning a polymer composition (e.g., to produce a composition of polymer nanofibers) including a fluorine-based polymer and a nitrile-based polymer onto an electrode including a current collector and an electrode active material layer on the current collector, and (2) electrospraying (e.g., the composition of polymer nanofibers) with an inorganic polymer composition including (e.g., a composition of) inorganic particles, a coating layer may be produced that functions as a separator and may be combined (e.g., integrated) with the electrode active material layer.

However, the coating layer formed through the (1) electrospinning process and the (2) electrospraying process may have a problem of weak durability, compared with a comparable separate (or related art) separator.

Accordingly, in some embodiments, a (3) heat pressing process is carried out, in addition to the (1) electrospinning process and the (2) electrospraying process, to enhance the durability of the coating layer.

For example, the (3) heat pressing process may increase the density of the coating layer and concurrently (e.g., simultaneously), thermally bond the polymer nanofibers included in (e.g., making of) the coating layer, resultantly, enhancing the durability of the coating layer.

In some embodiments, the durability of the coating layer is evaluated by two factors of puncture strength and tensile strength.

For example, the puncture strength of the coating layer may be about 15 gf to about 100 gf, about 15 gf to about 50 gf, or about 15 gf to about 30 gf. In some embodiments, the tensile strength of the coating layer may be about 120 kgf/cm² to about 300 kgf/cm², about 150 kgf/cm² to about 300 kgf/cm², or about 180 kgf/cm² to about 250 kgf/cm².

A method of measuring the puncture strength of the coating layer is not particularly limited but may utilize a method generally utilized in the related art of the present disclosure. Non-limiting examples of the method of measuring the puncture strength of the coating layer may be as follows:

After peeling off the coating layer from the electrode active material layer and cutting it at different ten points to obtain ten specimens, the ten specimens are respectively 10 times measured with respect to a piercing force required by pressing KATO Tech equipment with a probe, which are averaged to obtain the puncture strength.

A method of measuring the tensile strength of the coating layer is not particularly limited but may utilize a method generally utilized in the related art of the present disclosure. Non-limiting examples of the method of measuring the tensile strength of the coating layer are as follows:

After peeling off the coating layer from the electrode active material layer and cutting it into a rectangle shape with a width (MD) of 10 millimeter (mm)×a length (TD) of 50 mm at ten different points, each of the specimens is mounted on a UTM (universal tensile-testing machine), fixed thereinto to secure a measurement length of 20 mm, and pulled to measure average tensile strength.

### Thickness of Coating Layer

As the (3) heat pressing process is performed, the coating layer may have a thinner thickness compared to a coating layer manufactured only through the (1) electrospinning process and the (2) electrospraying process.

In more detail, a thickness of the coating layer may be about 5 micrometer (μm) to about 40 μm, about 7 μm to about 20 μm, or about 8 μm to about 16 μm.

### Polymer Nanofiber

The polymer nanofibers (e.g., composition of polymer nanofibers), which may be manufactured by electrospinning a polymer composition including a fluorine-based polymer and a nitrile-based polymer, may include a structural unit derived from the fluorine-based polymer and a structural unit derived from the nitrile-based polymer in one polymer nanofiber. Furthermore, during the electrospinning, at least a portion of the polymer nanofibers may be aggregated (e.g., gathered e.g., (together)) to form a woven structure.

Accordingly, the polymer nanofibers (e.g., composition of polymer nanofibers) may have advantages or be enhanced in terms of the components and the structure.

The fluorine-based polymer-derived unit may have excellent or suitable electrochemical stability and binding force, and may (e.g., play a role to) suppress one or more side reaction(s) during the charge and discharge of a rechargeable lithium battery.

In some embodiments, the nitrile-based polymer-derived unit may exhibit excellent or suitable insulation performance based on excellent or suitable thermal stability and mechanical stability, so that the rechargeable lithium battery may be stably operated, e.g., even in a high-temperature environment.

Accordingly, because the polymer nanofibers (e.g., composition of polymer nanofibers), include the structural unit derived from the fluorine-based polymer and the structural unit derived from the nitrile-based polymer in one polymer nanofiber, they may be suppressed or reduced from participating in one or more side reaction(s) during the charge and discharge of the rechargeable lithium battery. As a result, the rechargeable lithium battery may be stably operated, e.g., even in the high-temperature environment.

In some embodiments, the woven structure into which the polymer nanofibers (e.g., composition of polymer nanofibers) are aggregated (e.g., gathered e.g., (together)) has high porosity and low tortuosity (e.g., transport properties).

Accordingly, the woven structure into which the polymer nanofibers (e.g., composition of polymer nanofibers) are aggregated (e.g., gathered e.g., (together)) may improve mobility of lithium ions, compared with a polypropylene film generally utilized as a separator.

### Diameter of Polymer Nanofiber

In some embodiments, the polymer nanofibers in the composition of polymer nanofibers may have a diameter (e.g., an average diameter, a cross-sectional size or a cross-section diameter) of about 10 nanometer (nm) to about 1,000 nm, about 50 nm to about 200 nm, or about 50 nm to about 150 nm.

Within this range, a highly porous woven structure can be formed, improving the mobility of lithium ions.

### Fluorine-Based Polymer

The fluorine-based polymer is one of the raw materials of the polymer nanofibers, and the structural unit derived from the fluorine-based polymer refers to a structural unit formed by the fluorine-based polymer in the polymer nanofibers.

The fluorine-based polymer may be polyvinylidene fluoride, polyvinylidene fluoride-hexafluoropropylene, polyvinyl fluoride, polytetrafluoroethylene, or a combination thereof.

A weight average molecular weight of the fluorine-based polymer may be about 100,000 to about 1,500,000 g/mol, about 200,000 g/mol to about 1,300,000 g/mol, or about 300,000 to about 1,000,000 g/mol. Within this range, side reactions can be suppressed or reduced during charging and discharging of a rechargeable lithium battery.

### Nitrile-Based Polymer

The nitrile-based polymer is one of the raw materials of the polymer nanofibers, and the structural unit derived from the nitrile-based polymer refers to a structural unit formed by the nitrile-based polymer in the polymer nanofibers.

The nitrile-based polymer may be poly(meth)acrylonitrile, (meth)acrylonitrile-butadiene rubber, or a combination thereof.

A weight average molecular weight of the nitrile-based polymer may be about 10,000 to about 1,000,000 g/mol, about 30,000 to about 500,000 g/mol, or about 50,000 to about 100,000 g/mol. Within this range, the rechargeable lithium battery can be operated stably, e.g., even in a high-temperature environment.

In some embodiments, a weight ratio of the structural unit derived from the fluorine-based polymer to the structural unit derived from the nitrile-based polymer may be about 1:9 to about 9:1, about 3:7 to about 7:3, or about 5:5 to about 7:3. Within this range, side reactions are suppressed or reduced during charging and discharging of the rechargeable lithium battery, and the rechargeable lithium battery can be operated stably even in a high-temperature environment.

The weight ratio of the structural unit derived from the fluorine-based polymer and the structural unit derived from the nitrile-based polymer may correspond to the weight ratio of the fluorine-based polymer and the nitrile-based polymer in the raw materials (specifically, a polymer composition including the fluorine-based polymer and the nitrile-based polymer).

### Inorganic Particles

The inorganic particles may prevent or inhibit any likelihood for growth of lithium dendrites created by the woven structure formed by gathering the polymer nanofibers.

In some embodiments, because of the high porosity of the woven structure formed by gathering (e.g., aggregating) the polymer nanofibers, a relatively large portion of the electrode active material layer may be exposed and may not contact the polymer nanofibers relative to the total surface area of the electrode active material layer.

While there is an advantage or enhancement that the mobility of lithium ions improves as the exposed area of the electrode active material layer increases, there is also a disadvantage that lithium dendrites can easily grow. Because lithium dendrites are one of the main causes of short circuits in rechargeable lithium batteries, their growth needs to be suppressed or reduced. The inorganic particles may contribute to improving the safety (e.g., safety profile) and cycle-life of rechargeable lithium batteries by physically inhibiting the growth of lithium dendrites.

In some embodiments, each of the inorganic particles may be selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a combination thereof.

An average particle diameter (D50) of each of the inorganic particles may be about 10 to about 1,000 nm, about 50 to about 500 nm, or about 150 to about 300 nm.

In some embodiments, if (e.g., when) the inorganic particles are distributed on the surface of the electrode active material layer, they may (e.g., also act as a resistor to) prevent or reduce lithium ions from being intercalated into the electrode active material layer.

Accordingly, after the (1) electrospinning process of the polymer composition including the fluorine-based polymer and the nitrile-based polymer, and the (2) composition of inorganic particles is electrosprayed, the coating layer may have a gradient in which a distribution of the inorganic particles (e.g., composition of inorganic particles) gradually decreases from the upper portion to the lower portion of the coating layer. For example, an amount of the inorganic particles (e.g., composition of inorganic particles) in the upper portion of the coating layer may be greater (e.g., decreases) than an amount of the inorganic particles (e.g., composition of inorganic particles) in the lower portion of the coating layer. Formation of such a gradient may reduce resistance (e.g., have an effect of reducing resistance) on the surface of the electrode active material layer.

### Manufacturing Method of Coating Layer

As described herein, the coating layer may be manufactured by performing (3) a heat pressing process in addition to the (1) electrospinning process and (2) electrospraying process.

### Electrospinning

If (e.g., when) a polymer composition including the fluorine-based polymer and the nitrile-based polymer is electrospun on the electrode, a woven structure combined (e.g., integrated) with the electrode active material layer may be formed.

For example, in the process of electrospinning the polymer composition including the fluorine-based polymer and the nitrile-based polymer, polymer nanofibers including a structural unit derived from the fluorine-based polymer and a structural unit derived from the nitrile-based polymer are formed in one (e.g., single) polymer nanofiber. In some embodiments, a portion of the polymer nanofibers may be incorporated (e.g., thoroughly mixed) into the electrode active material layer, and the polymer nanofibers may be aggregated (e.g., gathered (e.g., together)) to form a woven structure.

The electrospinning process may be performed by positioning a nozzle pack consisting of tips with a hole size of 23 G (gauge) to 30 G and a collector roller at a regular interval, adding the polymer composition to the tips, placing an electrode with the electrode active material layer upward on the connector roller, and applying a voltage of about 10 kilovolt (kV) to about 80 kV to the tips. The number of the tips may be appropriately adjusted according to a type or kind, content (e.g., amount), and/or the like of the polymers included in the polymer composition, for example, about 1 to about 200.

The regular interval between the nozzle pack and the electrode may be about 5 centimeter (cm) to about 70 cm.

If (e.g., when) the tips have a hole size of 25 G to 30 G, a woven structure with a desired or suitable shape may be formed.

According to the electrospinning process, the polymer composition is sprayed and stretched in the form of nanofibers and thus spun in a cone shape onto the electrode active material layer, forming the polymer nanofibers. For example, the polymer nanofibers may be formed, (e.g., from the polymer composition), and may be suspended (e.g., while hanging) in the form of a droplet at an end of the tips due to surface tension. If (e.g., when) voltage is applied thereto to generate charge repulsion, the droplet may start to become deformed (e.g., in an opposite direction to the surface tension of the solution) and if (e.g., when) a threshold voltage is reached, the droplet may be sprayed from the tip, so that a jet (e.g., called to be a Taylor cone) may be collected in the collector roller.

Herein, the electrospinning process may be performed at about 18° C. to about 25° C. under relative humidity of about 0.3% to about 50%. If (e.g., when) the electrospinning process is performed under the temperature and relative humidity conditions, the polymer nanofibers may be spun, while maintaining a constant thickness thereof.

In some embodiments, a roll speed of the connector roller may be adjusted so that the woven structure may have an appropriate or suitable thickness, for example, in a range of about 0.1 meter per minute (m/min) to about 10 m/min. Furthermore, the polymer composition discharged from the tips may be adjusted to discharge a solid content (e.g., amount) at about 20 microliter per minute (μL/min) to about 100 milliliter per minute (mL/min).

In some embodiments, the tips may be minimized or reduced from mutual interference by appropriately adjusting the tip air (e.g., pressure) so that the electrospinning may uniformly occur. The tip air adjustment may be performed by flowing compressed air at a pressure of about 0.1 megapascal (MPa) to about 0.4 MPa.

After performing the electrospinning process, a drying process may be performed with hot air at about 70° C. to about 110° C.

The polymer composition may include a fluorine-based polymer, a nitrile-based polymer, and a solvent.

In the polymer composition, the solvent may be dimethyl acetate, dimethylformamide, acetone, or a combination thereof. Because the fluorine-based polymer and the nitrile-based polymer are non-aqueous, an organic solvent is utilized as the solvent.

In the composition for producing the polymer nanofibers, a content (e.g., amount) of the polymers may be about 5 wt % to about 50 wt % based on 100 wt % of the total composition. If (e.g., when) the polymer content (e.g., amount) is within the ranges, an organic layer may be formed with an appropriate or suitable thickness. If (e.g., when) the polymer content (e.g., amount) is less than about 5 wt %, the polymer nanofibers may be difficult to form during the electrospinning, but if (e.g., when) the polymer content (e.g., amount) is greater than about 50 wt %, the electrospinning itself may be impossible, as a tip is blocked during the electrospinning, or the polymer nanofibers may have a substantially nonuniform thickness.

### Electrospraying

If (e.g., when) an inorganic particle composition is electrosprayed onto the woven structure (e.g., polymer nanofibers) of the coating layer combined (e.g., integrated) with the electrode active material layer, an inorganic particle coating layer may be formed.

For example, while the inorganic particle composition is electrosprayed onto the woven structure (e.g., polymer nanofibers) of the coating layer combined (e.g., integrated) with the electrode active material layer, substantially most of the inorganic particles may be (e.g., piled up) on the surface of the woven structure, but a portion of the inorganic particles may be incorporated (e.g., thoroughly mixed) into the woven structure. Accordingly, the inorganic particles may be present in a gradient where an amount of the inorganic particles may be gradually (e.g., decreasingly) less (e.g., distributed) from the top of the woven structure to the bottom.

The electrospraying process may be carried out by positioning a nozzle pack consisting of tips with a hole size of 23 G to 30 G and a collector roller at a regular interval, adding the inorganic particle composition on the tips, placing an electrode with the electrode active material layer upward on the collector roller, and applying a voltage of about 10 kV to about 80 kV to the tips.

The number of the tips may be appropriately adjusted depending on types (kinds), contents, and/or the like of the inorganic materials included in the inorganic particle composition, for example, about 1 to about 200.

The regular internal between the nozzle pack and the electrode may be about 5 cm to about 70 cm.

If (e.g., when) the tips have a hole size of 25 G to 30 G, an inorganic particle coating layer with a desired or suitable shape may be formed.

Through the electrospraying process, the inorganic particle composition may be sprayed onto the electrode active material layer in the form of (e.g., a composition of) dots.

In some embodiments, a rolling speed of the connector roller may be adjusted so that the inorganic particle coating layer may be formed to have an appropriate or suitable thickness, for example, about 0.1 m/min to about 10 m/min. In some embodiments, the inorganic particle composition discharged from the tips may be adjusted to discharge a solid content (e.g., amount) of about 20 μL/min to about 100 mL/min.

Furthermore, the tips may be minimized or reduced from mutual interference by appropriately adjusting the tip air (e.g., pressure) to secure substantially uniform electrospinning. The tip air adjustment may be performed by flowing compressed air at a pressure of about 0.1 MPa to about 0.4 MPa.

After performing the electrospraying process, a drying process may be performed with hot air at about 90° C. to about 110° C.

The inorganic particle composition may include inorganic particles (e.g., the composition of inorganic particles), a binder, and a solvent.

In the inorganic particle composition, the inorganic particles (e.g., the composition of inorganic particles) are as described herein, and the solvent may be dimethyl acetate, N-methylpyrrolidone, dimethylformamide, acetone, ethanol, water, or a combination thereof.

The binder may be polyvinylidene fluoride, polyamideimide, polyvinylpyrrolidone, polyacrylonitrile, a copolymer thereof, or a combination thereof.

In the inorganic particle composition, a content (e.g., amount) of the inorganic particles (e.g., the composition of inorganic particles) may be about 10 wt % to about 40 wt % based on 100 wt % of the total composition.

### Heat Pressing

If (e.g., when) heat-pressed after forming the inorganic particle coating layer on the woven structure, the inorganic particles (e.g., the composition of inorganic particles) may be increasingly more incorporated (e.g., thoroughly mixed) into the woven structure, and the polymer nanofibers making up the woven structure may be bonded by the heat. Accordingly, a total density of the coating layer including the woven structure and the inorganic particle coating layer may increase.

Accordingly, if (e.g., when) the (3) heat pressing process is carried out in addition to the (1) electrospinning process and the (2) electrospraying process, the durability of the coating layer may be enhanced.

The heat pressing process may be performed with a roll press under a pressure of about 0.01 MPa to about 1 MPa, about 0.05 MPa to about 0.5 MPa, or about 0.1 MPa to about 0.5 MPa; at a temperature of about 80° C. to about 150° C., about 90° C. to about 140° C., or about 100° C. to about 120° C.; and at a tensile speed of about 10 centimeter per minute (cm/min) to about 50 cm/min, about 15 cm/min to about 45 cm/min, or about 20 cm/min to about 40 cm/min.

### Carbon Layered Foil Layer

In some embodiments, a carbon layered foil (CLF) layer may be further included between the current collector and the electrode active material layer.

If (e.g., when) the carbon layered foil layer is further included, conductivity at the surface of the current collector, may be improved and resistance may be reduced.

### Rechargeable Lithium Battery

Some embodiments provide a rechargeable lithium battery including the electrode assembly but excluding (e.g., not including) a separate separator.

The electrode assembly combines (e.g., integrates) a coating layer that functions as a separator with the electrode active material layer, and has enhanced durability (e.g., puncture strength and tensile strength).

Accordingly, if (e.g., when) the electrode assembly is utilized, the safety (e.g., safety profile) and lifespan of a rechargeable lithium battery may be improved.

In a rechargeable lithium battery of some embodiments, at least one selected from among a negative electrode and a positive electrode may be utilized as the electrode assembly.

However, if (e.g., when) the cross-sectional area of the negative electrode is larger than that of the anode, it may be advantageous to use the negative electrode as the electrode assembly rather than the positive electrode from the viewpoint of heat shrinkage.

Hereinafter, a rechargeable lithium battery according to some embodiments will be described in more detail, excluding redundant descriptions of the electrode assembly.

### Positive Electrode Active Material

The positive electrode active material may be a compound (lithiated intercalation compound) capable of intercalating and deintercalating lithium. For example, one or more types (kinds) of composite oxides of lithium and a metal selected from among cobalt, manganese, nickel, and a combination thereof may be utilized.

The composite oxide may be a lithium transition metal composite oxide, and specific examples may include lithium nickel-based oxide, lithium cobalt-based oxide, lithium manganese-based oxide, a lithium iron phosphate-based compound, cobalt-free lithium nickel-manganese-based oxide, or a combination thereof.

As an example, a compound represented by any of the following chemical formulas may be utilized. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, O≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); or LiₐFePO₄ (0.90≤a≤1.8).

In the preceding chemical formulas, A may be Ni, Co, Mn, or a combination thereof; X may be Al, Ni, Co, Mn, Cr, Fe, Mg, Sr, V, a rare earth element, or a combination thereof; D may be O, F, S, P, or a combination thereof; G may be Al, Cr, Mn, Fe, Mg, La, Ce, Sr, V, or a combination thereof; and L¹ may be Mn, Al, or a combination thereof.

An example of the positive electrode active material may be or include a high nickel-based positive electrode active material having a nickel content (e.g., amount) of greater than or equal to about 80 mol %, greater than or equal to about 85 mol %, greater than or equal to about 90 mol %, greater than or equal to about 91 mol %, or greater than or equal to about 94 mol %, and less than or equal to about 99 mol % based on 100 mol % of metals excluding lithium in the lithium transition metal composite oxide. The high nickel-based positive electrode active materials may achieve high capacity and may be applied to a high-capacity, high-density rechargeable lithium battery.

### Positive Electrode

The positive electrode for a rechargeable lithium battery may include a current collector and a positive electrode active material layer on the current collector. The positive electrode active material layer may include a positive electrode active material and may further include a binder and/or a conductive material.

For example, the positive electrode may further include an additive that can serve as a sacrificial positive electrode.

An amount of the positive electrode active material may be about 90 wt % to about 99.5 wt % based on 100% by weight of the positive electrode active material layer, and amounts of the binder and the conductive material may be about 0.5 wt % to about 5 wt %, respectively, based on 100 wt % of the positive electrode active material layer.

The binder serves to attach the positive electrode active material particles well to each other, and also to attach the positive electrode active material well to the current collector. Examples of the binder may be polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and a combination thereof, but are not limited thereto.

The conductive material may be utilized to impart conductivity (e.g., electrical conductivity) to the electrode and any material that does not cause chemical change (e.g., does not cause an undesirable chemical change in the rechargeable lithium battery) and conducts electrons may be utilized in the battery. Examples of the conductive material may include a carbon-based material such as natural graphite, artificial graphite, carbon black, acetylene black, ketjen black, a carbon fiber, a carbon nanofiber, and/or a carbon nanotube; a metal-based material including copper, nickel, aluminum, silver, and/or the like, in a form of a metal powder or a metal fiber; a conductive polymer such as a polyphenylene derivative; or a mixture thereof.

The current collector may include Al, but is not limited thereto.

### Negative Electrode Active Material

The negative electrode active material may be a material that reversibly intercalates/deintercalates lithium ions, a lithium metal, a lithium metal alloy, a material capable of doping and dedoping lithium, and/or a transition metal oxide.

The material that reversibly intercalates/deintercalates lithium ions may include a carbon-based negative electrode active material, for example, crystalline carbon, amorphous carbon or a combination thereof. The crystalline carbon may be graphite such as irregular-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and/or the like.

The lithium metal alloy may include lithium and a metal selected from among Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x≤2), a Si-Q alloy (wherein Q is selected from among an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. According to some embodiments, the silicon-carbon composite may be in a form of silicon particles (e.g., primary silicon particles) and amorphous carbon coated on the surface of the silicon particles (e.g., primary silicon particles). For example, the silicon-carbon composite may include a secondary particle (core) in which the primary silicon particles are assembled, and an amorphous carbon coating layer (shell) on the surface of the secondary particle (core). The amorphous carbon may also be between the primary silicon particles, and, for example, the primary silicon particles may be coated with the amorphous carbon. The secondary particle (core) may be (e.g., exist) dispersed in an amorphous carbon matrix.

The silicon-carbon composite may further include crystalline carbon. For example, the silicon-carbon composite may include a core including crystalline carbon and the primary silicon particles and an amorphous carbon coating layer on a surface of the core.

The Si-based negative electrode active material or the Sn-based negative electrode active material may be utilized in combination with a carbon-based negative electrode active material.

### Negative Electrode

The negative electrode for a rechargeable lithium battery may include a current collector and a negative electrode active material layer on the current collector. The negative electrode active material layer may include a negative electrode active material and may further include a binder and/or a conductive material. In some embodiments, the negative electrode for a rechargeable lithium battery is an electrode assembly (negative electrode assembly) in the aforementioned embodiment, and may further include the aforementioned coating layer on the negative electrode active material layer.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other, and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from among a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

If (e.g., when) an aqueous binder is utilized as the negative electrode binder, it may further include a cellulose-based compound capable of imparting viscosity. The cellulose-based compound may include one or more of (e.g., selected from among) carboxylmethyl cellulose, hydroxypropylmethyl cellulose, methyl cellulose, and/or alkali metal salts thereof. The alkali metal may be Na, K, or Li.

The dry binder may be a polymer material capable of being fiberized, and may be, for example, polytetrafluoroethylene, polyvinylidene fluoride, polyvinylidene fluoride-hexafluoropropylene copolymer, polyethylene oxide, or a combination thereof.

The conductive material may be included to provide electrode (e.g., electronic) conductivity, and any electrically conductive material may be utilized as a conductive material unless it causes a chemical change. Examples of the conductive material may be a carbon-based material such as natural graphite, artificial graphite, carbon black, acetylene black, ketjen black, a carbon fiber, a carbon nanofiber, a carbon nanotube, and/or the like; a metal-based material such as copper, nickel, aluminum silver, and/or the like in a form of a metal powder or a metal fiber; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof, but is not limited thereto.

### Electrolyte

The electrolyte for a rechargeable lithium battery may include a non-aqueous organic solvent and a lithium salt.

The non-aqueous organic solvent serves as a medium for transmitting ions taking part in the electrochemical reaction of a battery.

The non-aqueous organic solvent may be a carbonate-based, ester-based, ether-based, ketone-based, alcohol-based solvent, aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethylacetate, methylpropionate, ethylpropionate, decanolide, mevalonolactone, valerolactone (valerolactone), caprolactone, and/or the like. The ether-based solvent may include dibutyl ether, tetraglyme, diglyme, dimethoxyethane, 2-methyltetrahydrofuran, 2,5-dimethyltetrahydrofuran, tetrahydrofuran, and/or the like. The ketone-based solvent may include cyclohexanone. The alcohol-based solvent may include ethyl alcohol, isopropyl alcohol, and/or the like, and the aprotic solvent may include nitriles such as R-CN (wherein R is a C2 to C20 linear, branched, or cyclic hydrocarbon group, a double bond, an aromatic ring, or an ether group), amides such as dimethylformamide, dioxolanes such as 1,3-dioxolane or 1,4-dioxolane, sulfolanes, and/or the like.

The non-aqueous organic solvent may be utilized alone or as a mixture of two or more.

Additionally, if (e.g., when) utilizing a carbonate-based solvent, a cyclic carbonate and a chain carbonate may be mixed and utilized, and the cyclic carbonate and the chain carbonate may be mixed at a volume ratio of about 1:1 to about 1:9.

The lithium salt dissolved in the organic solvent supplies lithium ions in a battery, enables a general or suitable operation of a rechargeable lithium battery, and improves transportation of the lithium ions between positive and negative electrodes. Examples of a lithium salt may include at least one selected from among LiPF₆, LiBF₄, LiSbF₆, LiAsF₆, LiClO₄, LiAlO₂, LiAlCl₄, LIPO₂F₂, LICl, LiI, LIN (SO₃C₂F₅)₂, Li(FSO₂)₂N (lithium bis(fluorosulfonyl)imide, LiFSI), LiC₄F₉SO₃, LIN(CₓF₂ₓ₊₁SO₂)(C_{y}F_{2y+1}SO₂) (x and y are integers from 1 to 20), lithium trifluoromethane sulfonate, lithium tetrafluoroethanesulfonate, lithium difluorobis(oxalato)phosphate, (LiDFOB), and lithium bis(oxalato) borate (LiBOB).

### Separator

As described herein, the rechargeable lithium battery according to some embodiments may not include (e.g., may exclude) a separate separator.

### Rechargeable Lithium Battery

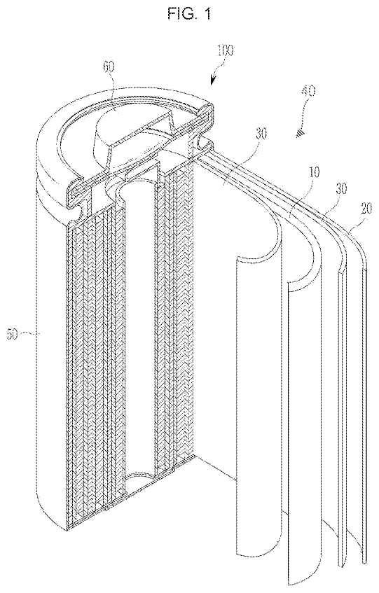

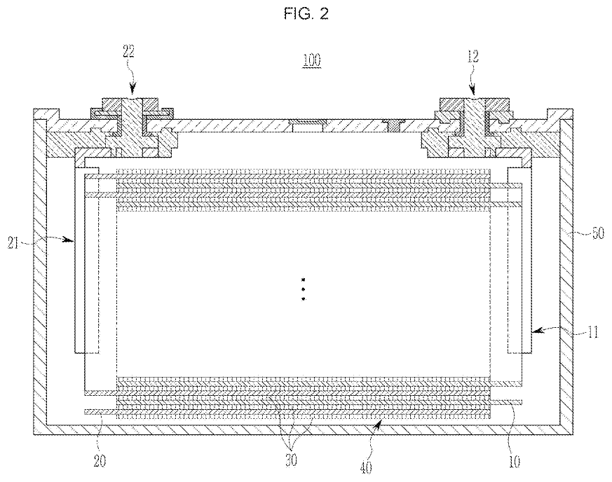

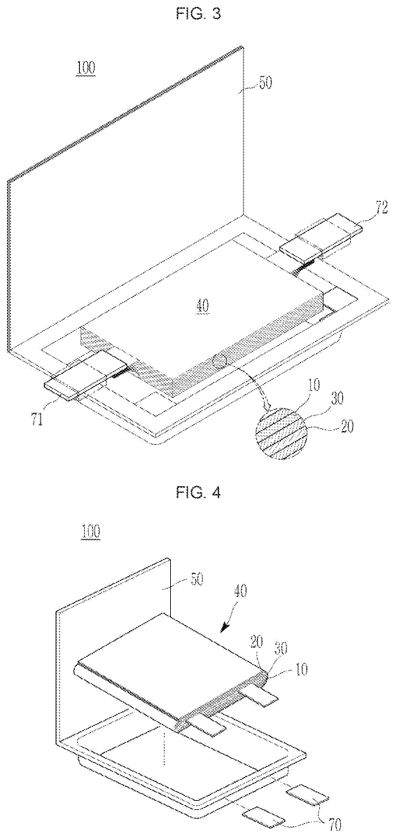

The rechargeable lithium battery may be classified into cylindrical, prismatic, pouch, or coin-type or kind batteries, and/or the like depending on the shape thereof. FIGS. 1 to 4 are schematic views showing generally suitable rechargeable lithium batteries, wherein FIG. 1 shows a circular one, FIG. 2 shows a prismatic one, and FIGS. 3 and 4 show pouch-type or kind ones. Referring to FIGS. 1 to 4, the rechargeable lithium battery 100 includes an electrode assembly 40 with a separator 30 interposed between the positive electrode 10 and the negative electrode 20, and a case 50 in which the electrode assembly 40 is housed. The positive electrode 10, negative electrode 20, and separator 30 may be impregnated with an electrolyte. The rechargeable lithium battery 100 may include a sealing member 60 that seals the case 50 as shown in FIG. 1. Additionally, in FIG. 2, the rechargeable lithium battery 100 may include a positive electrode lead tab 11, a positive electrode terminal 12, a negative lead tab 21, and a negative electrode terminal 22. As shown in FIG. 3, the rechargeable lithium battery 100 includes a positive electrode tab 71 and a negative electrode tab 72, which serve as an electrical path for guiding the current formed in the electrode assembly 40 to the outside. As shown in FIG. 4, the rechargeable lithium battery 100 includes electrode tabs 70.

However, the rechargeable lithium battery according to some embodiments may exclude the separator 30 from the battery form of FIGS. 1 to 4.

The rechargeable lithium battery according to some embodiments may be applied to automobiles, mobile phones, and/or one or more suitable types (kinds) of electrical devices, but the present disclosure is not limited thereto.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or +30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

Hereinafter, examples and comparative examples of the present disclosure will be described. However, the following example is only an example of the present disclosure, and the present disclosure is not limited to the following examples.

### EXAMPLES

### Example 1

### (1) Manufacture of Electrode Assembly (Negative Electrode Assembly)

### Manufacture of Negative Electrode

97.5 wt % of artificial graphite, 1.0 wt % of carboxylmethyl cellulose (CMC), and 1.5 wt % of styrene butadiene rubber (SBR) were mixed in a water solvent to prepare a negative electrode active material slurry. The negative electrode active material slurry was coated on a copper current collector and then, dried and pressed to form a negative electrode active material layer, which was utilized to manufacture a negative electrode.

### Electrospinning

A polymer composition was electrospun on the negative electrode active material layer of the negative electrode.

The polymer composition was prepared by mixing polyvinylidene fluoride (a weight average molecular weight: 495,000 g/mol) and polyacrylonitrile (a weight average molecular weight: 85,000 g/mol) in a weight ratio of 7:3 in a dimethyl acetate solvent (a solid content (e.g., amount): 16 wt %).

The electrospinning process was carried out by the following method.

After positioning a nozzle pack consisting of 48 tips with a hole size of 25 G (gauge) and a collector roller at an interval of 15 centimeter (cm), the polymer composition was added to the tips and then, electrospun at 20° C. under relative humidity of 50% by applying a voltage of 40 kilovolt (kV) to 50 kV thereto. Herein, the collector roller was set at a rolling speed of 0.1 meter per minute (m/min) to 0.5 m/min, and the polymer composition discharged at the tips was set to have a solid content (e.g., amount) of 20 microliter per minute (μL/min). In some embodiments, the electrospinning was carried out by flowing a compressed air under a pressure of 0.3 megapascal (MPa).

After the electrospinning was completed, drying with hot air was performed at 90° C. to provide (e.g. a composition of) polymer nanofibers.

Accordingly, the (e.g. composition of) polymer nanofibers were aggregated (i.e., gathered together) to form a woven structure (a thickness: 15 micrometer (μm)). The (e.g., each of the) polymer nanofibers had a diameter (e.g., an average diameter or cross-section size) of about 150 nanometer (nm) and included a structural unit derived from a fluorine-based polymer and a structural unit derived from a nitrile-based polymer in a weight ratio of 7:3.

### Electrospraying

An inorganic particle composition was electrosprayed onto the woven structure formed by gathering the polymer nanofibers.

The inorganic particle composition included alumina (D50: 250 nm) and a binder in a weight ratio of 20:1 in a mixed solvent of water and ethanol mixed in a weight ratio of 6:4 (a solid content (e.g., amount): 20 wt %). The binder was a mixed binder of polyvinyl alcohol and polyether.

The electrospraying process was performed by the following method.

After positioning a nozzle pack consisting of 48 tips with a hole size of 25G (25 gauge) and a collector roller at an interval of 15 cm and adding the inorganic particle composition to the tips, the electrospraying was performed at 20° C. under relative humidity of 50% by applying a voltage of 40 kV to 50 kV thereto. Herein, the connector roller was set at a rolling speed of 0.1 m/min to 0.5 m/min, and the inorganic particle composition discharged from the tips was set to have a solid content (e.g., amount) of 10 μL/min. In some embodiments, the electrospraying was carried out under a pressure of 0.3 MPa by flowing compressed air.

After the electrospraying was completed, drying with hot air was performed at 90° C.

Accordingly, an inorganic particle coating layer (a thickness: 19 μm) including alumina (D50: 250 nm) was formed on the woven structure formed through aggregation (i.e., gathering) of the (e.g. composition of) polymer nanofibers.

### Heat Pressing

After sequentially carrying out the electrospinning and the electrospraying, a heat pressing process was carried out at 100° C. under a pressure of 0.2 MPa at a tensile speed of 30 centimeter per minute (cm/min). Accordingly, the final electrode assembly was obtained.

In the finally obtained electrode assembly, the coating layer has a total thickness of 12 μm, in which inorganic particles were gradually more distributed from the bottom of the coating layer to the top. For example, an amount of inorganic particles in an upper portion of the coating layer was greater than an amount of inorganic particles in a lower portion of the coating layer.

### (2) Manufacture of Positive Electrode

96 wt % of LiCoO₂, 2 wt % of ketjen black, and 2 wt % of polyvinylidene fluoride were mixed in an N-methyl pyrrolidone solvent to prepare a positive electrode active material slurry. The positive electrode active material slurry was coated on an Al current collector and then, dried and pressed to manufacture a positive electrode.

### (3) Manufacture of Rechargeable Lithium Battery Cells

After stacking the coating layer of the electrode assembly (i.e., negative electrode assembly) in contact with the positive electrode, an electrolyte was injected thereinto to manufacture a rechargeable lithium battery cell. The electrolyte was prepared by dissolving 1.15 M LiPF₆ in a solvent of ethylene carbonate, ethylmethyl carbonate, and dimethyl carbonate in a volume ratio of 30:40:40.

### Example 2

An electrode assembly (i.e., negative electrode assembly) and a rechargeable lithium battery cell were manufactured in substantially the same manner as in Example 1 except that the weight ratio of polyvinylidene fluoride and polyacrylonitrile was changed to 6:4 during the electrospinning.

### Example 3

An electrode assembly (i.e., negative electrode assembly) and a rechargeable lithium battery cell were manufactured in substantially the same manner as in Example 1 except that the weight ratio of polyvinylidene fluoride and polyacrylonitrile was changed to 5:5 during the electrospinning.

### Example 4

An electrode assembly (i.e., negative electrode assembly) and a rechargeable lithium battery cell were manufactured in substantially the same manner as in Example 1 except that the heat pressing process condition was changed to form a coating layer with a total thickness of 16 μm.

### Comparative Example 1

An electrode assembly (i.e., negative electrode assembly) and a rechargeable lithium battery cell were manufactured in substantially the same manner as in Example 1 except that the heat pressing process was omitted (e.g., not carried out).

### 1 Comparative Example 2

An electrode assembly (i.e., negative electrode assembly) and a rechargeable lithium battery cell were manufactured in substantially the same manner as in Example 3 except that the heat pressing process was omitted (e.g., not carried out).

### Comparative Example 3

An electrode assembly (i.e., negative electrode assembly) and a rechargeable lithium battery cell were manufactured in substantially the same manner as in Example 1 except that the electrospraying process was omitted (e.g., not carried out).

### Evaluation Example 1: Evaluation of Physical Properties of Coating Layer

Each of the electrode assemblies (i.e., negative electrode assemblies) of Examples 1 to 4 and Comparative Examples 1 to 3 was measured with respect to puncture strength and tensile strength in the following method. The results are shown in Table 1.

Puncture strength: after peeling off the coating layer from the electrode active material layer and cutting it at ten different horizontal points to prepare ten specimens, the ten specimens were respectively ten times measured with respect to a piecing force required if (e.g., when) pressed with a probe by utilizing KATO Tech equipment, which were averaged to obtain the puncture strength.

Tensile strength: after peeling off the coating layer from the electrode active material layer and cutting it into a rectangle with a width (MD) 10 millimeter (mm)×a length (TD) 50 mm at ten different points to prepare ten specimens, the ten specimens were mounted on a UTM (Universal Tensile-testing Machine) and clipped to secure a length of 20 mm and then, pulled to measure average tensile strength.

TABLE 1

| | Example | Example | Example | Example | Comparative | Comparative | Comparative |
|---|---|---|---|---|---|---|---|
| | 1 | 2 | 3 | 4 | Example 1 | Example 2 | Example 3 |
| Puncture | 20 | 21 | 25 | 18 | 13 | 19 | 14 |
| strength (gf) | | | | | | | |
| Tensile strength | 210 | 218 | 230 | 182 | 98 | 69 | 119 |
| (kgf/cm²) | | | | | | | |

### Evaluation Example 2: Evaluation of Room-Temperature Charge/Discharge Cycle Characteristics

The rechargeable lithium battery cells of Examples 1, 3, and 4 and Comparative Examples 1 to 3 were charged and discharged to evaluate cycle characteristics, and the results are shown in Table 2.

Subsequently, the cells were 200 cycles charged at 0.5 C (CC/CV, 4.25 V, 0.025 C Cut-off) and discharged at 0.5 C (CC, 2.5 V Cut-off) at 25° C. to evaluate a capacity retention rate.

### Equation 1

Capacity retention rate=(discharge capacity after 200 cycles/discharge capacity after 1 cycle)*100

On the other hand, each of the rechargeable lithium battery cells of Examples 1, 3, and 4 and Comparative Examples 1 to 3 was measured with respect to ΔV/ΔI (voltage change/current change) to evaluate initial DC internal resistance (DC-IR).

TABLE 2

| | Capacity retention | Initial DC resistance |
|---|---|---|
| | rate (@25° C., 200th Cycle) | @25° C. (mΩ) |
| Example 1 | 90 | 2.28 |
| Example 3 | 98 | 2.66 |
| Example 4 | 89.9 | 2.64 |
| Comparative Example 1 | 83 | 2.91 |
| Comparative Example 2 | 85 | 3.00 |
| Comparative Example 3 | 78 | 2.65 |

### SUMMARY

Referring to Tables 1 and 2, compared with Comparative Examples 1 and 2, in which a coating layer was formed through the (1) electrospinning process and the (2) electrospraying process alone, Examples 1 to 4, in each of which the (3) heat pressing process was added thereto to form a coating layer, exhibited significantly improved puncture strength and tensile strength but reduced initial DC resistance.

On the other hand, Comparative Example 3, in which a coating layer was formed through the (1) electrospinning process and the (3) heat pressing process alone, exhibited improved tensile strength, compared with Comparative Examples 1 and 2, but lower puncture strength and tensile strength than Examples 1 to 4 and also, deteriorated cycle-life.

Accordingly, the electrode assembly according to some embodiments, which was represented by Examples 1 to 4, exhibited enhanced durability, while combining (e.g., integrating) a coating layer functioning as a separator with an electrode active material layer and improved the safety (e.g., safety profile) and a cycle-life of rechargeable lithium batteries.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

While this disclosure has been described in connection with what is presently considered to be practical example embodiments, it is to be understood that the present disclosure is not limited to the disclosed embodiments, but, on the contrary, is intended to cover one or more suitable modifications and equivalent arrangements included within the spirit and scope of the appended claims, and equivalents thereof.

### DESCRIPTION OF SYMBOLS

100: rechargeable lithium battery
10: positive electrode
20: negative electrode
30: separator
50: case
60: sealing member

What is claimed is:

1. An electrode assembly, the electrode assembly comprising
a current collector;
an electrode active material layer on the current collector; and
a coating layer combined with the electrode active material layer,
the electrode assembly being for a rechargeable lithium battery,
wherein the coating layer comprises:
a composition of polymer nanofibers each polymer nanofiber comprising a structural unit derived from a fluorine-based polymer and a structural unit derived from a nitrile-based polymer; and
a composition of inorganic particles, and
the coating layer has a puncture strength of about 15 to about 100 gram force (gf) and a tensile strength of about 120 to about 1,000 kilogram force per square centimeter (kgf/cm²).

2. The electrode assembly as claimed in claim 1, wherein the composition of polymer nanofibers has a woven structure.

3. The electrode assembly as claimed in claim 1, wherein
a weight ratio of the structural unit derived from the fluorine-based polymer and the structural unit derived from the nitrile-based polymer is about 1:9 to about 9:1.

4. The electrode assembly as claimed in claim 1, wherein
the fluorine-based polymer is polyvinylidene fluoride, polyvinylidene fluoride-hexafluoropropylene, polyvinyl fluoride, polytetrafluoroethylene, or a combination thereof.

5. The electrode assembly as claimed in claim 1, wherein
the nitrile-based polymer is poly(meth)acrylonitrile, (meth)acrylonitrile-butadiene rubber, or a combination thereof.

6. The electrode assembly as claimed in claim 1, wherein
an average diameter of the polymer nanofibers is about 10 nanometer (nm) to about 1,000 nm.

7. The electrode assembly as claimed in claim 1, wherein
an amount of inorganic particles in an upper portion of the coating layer is greater than an amount of the composition of inorganic particles in a lower portion of the coating layer.

8. The electrode assembly as claimed in claim 1, wherein
each inorganic particle comprises Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

9. The electrode assembly as claimed in claim 1, wherein
an average particle diameter (D50) each inorganic particle is about 10 to about 1,000 nm.

10. The electrode assembly as claimed in claim 1, wherein
a thickness of the coating layer is about 5 micrometer (μm) to about 40 μm.

11. The electrode assembly as claimed in claim 1, wherein
a carbon layered foil (CLF) layer is between the current collector and the electrode active material layer.

12. A rechargeable lithium battery comprising the electrode assembly as claimed in claim 1, the rechargeable lithium battery excluding a separate separator.
